(19) United States
(12) Patent Application Publication
(10) Pub. No.: US 2025/0332752 A1
(43) Pub. Date: Oct. 30, 2025

(54) SLICING MACHINE AND METHOD FOR SLICING FOODSTUFFS

(71) Applicant: MULTIVAC SEPP HAGGENMÜLLER SE & CO. KG, Wolfertschwenden (DE)

(72) Inventor: Alexander KAST, Memmingen (DE)

(73) Assignee: MULTIVAC SEPP HAGGENMÜLLER SE & CO. KG, Wolfertschwenden (DE)

(21) Appl. No.: 19/189,607

(22) Filed: Apr. 25, 2025

(30) Foreign Application Priority Data
Apr. 26, 2024 (DE) 102024111792.3

(51) Int. Cl. B26D 1/18

(52) U.S. Cl. CPC B26D 1/18

(57) ABSTRACT

A slicing machine for slicing foodstuffs includes a feed unit designed to feed at least one product caliber along a feed direction, and a cutting unit designed to cut the at least one product caliber into slices. The cutting unit comprises a knife rotatably drivable about an axis. The cutting unit is designed to carry out a disengagement movement to carry out one or more blank cuts, in which the knife is moved along a direction substantially parallel to the axis from a slicing position to a blank cut position. The cutting unit is designed to perform an engagement movement of the knife from the blank cut position to the slicing position after the one or more blank cuts have been performed, wherein the knife executes a movement about the axis during the engagement movement which corresponds to more than one complete revolution of the knife about the axis.

### CROSS-REFERENCE TO RELATED APPLICATIONS

This application claims foreign priority benefits under 35 U.S.C. § 119(a)-(d) to German patent application number DE 102024111792.3, filed Apr. 26, 2024, which is incorporated by reference in its entirety.

### SUMMARY

The disclosure relates to a slicing machine, in particular a slicer, for slicing foodstuffs, comprising a feed unit which is designed to feed at least one product caliber along a feed direction, and a cutting unit which is designed to slice the at least one product caliber, wherein the cutting unit comprises a knife which can be rotatably driven about an axis of rotation, and wherein the cutting unit is designed and intended to carry out a disengagement movement in order to carry out one or more blank cuts, in which the knife is moved along a direction substantially parallel to the axis of rotation of the knife from a slicing position which is intended to slice the at least one product caliber into slices, to a blank cut position in which no slice is cut from the at least one product caliber during a respective rotation of the knife about the axis of rotation.

Already at this point it should be noted that the slicing machine according to the disclosure is intended to slice foodstuffs in the form of so-called “product calibers” into slices, from which preferably shingled and/or stacked portions can be formed. The product calibers can in this connection be formed for example from sausage, cheese, grown meat, pressed meat and the like. The feed unit can be designed, for example, as an endlessly circulating belt conveyor or the like. Preferably, the cutting unit is arranged downstream of the feed unit with respect to the feed direction. By means of the knife, which is mounted on the cutting unit, the slices can be separated from an end of a respective product caliber facing the cutting unit.

Furthermore, the product calibers are preferably fed by means of an inclined, downwardly directed feed conveyor of the feed unit in the direction of the knife of the cutting unit, so that the slices are already oriented at an angle while being separated and can fall onto a discharge conveyer of a discharge unit of the slicing machine, by means of which the slices can be removed for further processing. Accordingly, the knife can also be arranged with its cutting plane inclined relative to the vertical direction and protruding forwards in the feed direction.

As a rule the product calibers are cut into portions by means of the slicing machine, each of which can consist of several slices. After a portion has been completely sliced, one or more blank cuts are usually performed in order to give the discharge conveyor of the discharge unit sufficient time to convey the finished portion away in a discharge direction. A blank cut is defined as meaning that no slice is cut from the at least one product caliber during each rotation of the knife about the axis of rotation. This can be made possible by the fact that the cutting unit, in particular the knife, executes the disengagement movement to the blank cut position in which no slices are cut from the at least one product caliber, despite a rotation of the knife about the axis of rotation.

After a desired number of blank cuts have been performed, the knife must be moved back again from the blank cut position to the slicing position along the direction substantially parallel to the axis of rotation of the knife, which corresponds to an engagement movement of the knife.

All the afore-described also applies to the slicing machine according to the disclosure.

In the case of known slicing machines the disengagement movement and engagement movement are usually performed relatively quickly, for example within at most one knife revolution or less, since otherwise so-called shredding can occur, in which misshapen or unusable slices or partial slices are cut off from the product caliber.

Since, as mentioned in the introduction, the knife with its cutting plane is usually inclined relative to a vertical direction and protrudes forwards in the feed direction, then depending on the angle of inclination of the cutting plane the force of gravity acting on the cutting unit, in particular on the knife, must also be at least partially overcome during the engagement movement. This can lead to high accelerations and/or speeds, especially during the engagement movement, and thus to considerable loading or increased wear on a blank cut drive unit of the cutting unit, which is designed to perform the engagement movement and preferably also the disengagement movement. This effect can be further intensified by particularly high knife speeds of up to 1000 rpm and more, since the engagement and disengagement movements must be carried out correspondingly faster.

It is therefore an object of the disclosure to alleviate this situation, in particular by providing a slicing machine which has the lowest possible susceptibility to wear and/or maintenance requirements and is therefore suitable for minimizing as far as possible the risk of snippet formation during the execution of blank cuts.

This object is achieved according to the disclosure by a slicing machine of the type mentioned in the introduction, in which the cutting unit is designed and intended to perform an engagement movement of the knife from the blank cut position to the slicing position after the execution of the one or more blank cuts, wherein the knife executes a movement about the axis of rotation during the engagement movement that corresponds to more than one complete revolution of the knife about the axis of rotation.

In other words, according to the disclosure the engagement movement of the knife from the blank cut position to the slicing position extends, in particular with respect to time, over more than one knife revolution, so that more time is available for the engagement movement of the knife, which is particularly beneficial for the blank cut drive unit of the cutting unit. The engagement speed and/or engagement acceleration required for the engagement movement can thereby be significantly reduced, resulting in less wear and tear and thus greater ease of maintenance of the entire slicing machine. Accordingly, the engagement movement can also be referred to as a “gentle engagement” according to the disclosure.

Preferably the knife is moved substantially in the feed direction when performing the disengagement movement and/or is moved substantially opposite to the feed direction when carrying out the engagement movement.

According to a preferred embodiment, it is proposed that the movement of the knife about the axis of rotation during the engagement movement corresponds to a plurality of complete revolutions, preferably two complete revolutions, of the knife about the axis of rotation. In other words, the engagement movement of the knife can extend over a rotation of the knife through an angle of several complete revolutions, preferably approximately or exactly equal to 720°, about the axis of rotation. In order to further reduce the engagement speed and/or the engagement acceleration, the engagement movement can extend by even more than two revolutions or even more than 720°, provided this does not prolong the engagement procedure of the knife to an undesirable extent.

It is furthermore proposed that the start of the engagement movement essentially corresponds to a cutting start rotation angle position of the knife about the axis of rotation in which the cutting start rotation angle position corresponds to a rotation angle position of the knife about the axis of rotation at which the knife, in particular a cutting edge of the knife, engages with the product caliber for the first time when slicing a respective slice in the slicing position. If the engagement movement extends for example over two or more revolutions, the engagement movement is then in the best case completed immediately before or at the point in time at which the knife again reaches the cutting start rotation angle position to slice the next slice from the product caliber. Consequently, the engagement movement can be started as early as possible, and the time available for this procedure can be maximized without increasing the risk of shredding, since the engagement movement is completed even before or at least at the start of slicing the next slice from the product caliber.

In addition or alternatively, a start of the disengagement movement can essentially correspond to a cutting end rotation angle position of the knife about the axis of rotation, wherein the cutting end rotation angle position can correspond to a rotation angle position of the knife about the axis of rotation at which the knife no longer engages with the product caliber for the first time after a slicing of a respective slice in the slicing position. The disengagement movement preferably begins immediately at the cutting end rotation angle position in order to be able to utilize a maximum rotation angle range of the knife for the disengagement movement. Consequently, the disengagement movement can also be started as early as possible, and accordingly the time available for this can be maximized in a similar way without increasing the risk of shredding.

According to a preferred embodiment, it is proposed that an engagement stroke of the engagement movement against the feed direction and/or a disengagement stroke of the disengagement movement in the feed direction is/are greater in magnitude than a minimum stroke that is required to prevent engagement of the knife with the product caliber in the blank cut position, wherein the engagement stroke and/or the disengagement stroke preferably corresponds/correspond to at least approximately twice the minimum stroke. Consequently, even after completion of part of the engagement movement there is still no undesired contact between the knife and the product caliber, i.e. no shred formation, even if the engagement movement extends over several knife revolutions about the axis of rotation. So long as the engagement movement therefore extends for example over two knife revolutions, the engagement movement can be subdivided into two partial movements opposite to the feed direction, wherein each partial movement can correspond in magnitude to the minimum stroke. Preferably the two partial movements merge continuously into one another however, which means that the knife can move continuously, i.e., without interruption, from the blank cut position to the slicing position. The minimum stroke required for a blank cut can also be referred to as the blank cut path.

Furthermore, the cutting unit can be designed to perform the disengagement movement with an acceleration and/or a speed which is/are higher than an acceleration and/or a speed of the engagement movement. Particularly in the case of a knife arranged at a slant with respect to a vertical direction, the disengagement movement can nevertheless be performed faster than the engagement movement without this resulting in excessively high loads on the cutting unit, in particular on the blank cut drive unit, since the disengagement movement can have a directional component which can extend substantially parallel to the force of gravity or in the direction of gravity. A rapid disengagement movement can prevent the formation of chips even more effectively.

In order to prevent a portion of the product caliber protruding into the cutting plane or beyond the latter in the feed direction from being sliced off during the disengagement movement, according to a further embodiment it is proposed that the cutting unit be configured to perform at least part of the disengagement movement, preferably only within a clearance angle range of the knife in which the knife in the slicing position does not engage with the product caliber upon rotation about the axis of rotation. Accordingly, at least part of the disengagement movement, in particular the minimum stroke, is preferably executed only in the clearance angle range so as to be able to prevent even more effectively the formation of shreds.

According to a particularly preferred embodiment the knife can be designed as a sickle knife, wherein the sickle knife can preferably have a variable radius, in particular an increasing radius, in the circumferential direction about the axis of rotation. If the knife is designed as a sickle knifed, the afore-mentioned cutting start rotation angle position can correspond to a rotation angle position of the sickle knife about the axis of rotation at which the sickle knife engages with the product caliber for the first time when a respective slice is sliced in the slicing position. The cutting end rotation angle position on the other hand can correspond to a rotation angle position of the sickle knife about the axis of rotation at which for the first time the sickle knife no longer engages with the product caliber after a respective slice has been sliced off in the slicing position. A clearance angle range can accordingly be located between the cutting end rotation angle position and the cutting start rotation angle position, in which the sickle knife does not engage with the product caliber during rotation about the axis of rotation, even in the slicing position.

Furthermore, the disengagement movement and/or the engagement movement can have a stroke in the feed direction in a range of, in particular, more than 0 mm to 10 mm, preferably from 3 mm to 5 mm. Since the knife moves by more than one complete revolution about the axis of rotation during the engagement movement and thus more time is available for the engagement movement, the stroke can accordingly also be selected to be larger for the engagement movement without resulting in an excessive load on the blank cut drive unit of the cutting unit. With a constant stroke the load, i.e. the acceleration or force acting on the blank cut drive unit, is reduced accordingly. Since the disengagement movement preferably has a directional component parallel to the direction of the force of gravity, it can in principle be performed at a higher speed and/or acceleration without resulting in disruptive loads on the blank cut drive unit, so that the stroke can also be chosen to be correspondingly large for this purpose.

However, since the disengagement movement preferably has a directional component pointing in the direction of gravity and/or parallel to gravity, it is further proposed that the cutting unit be designed to execute a movement about the axis of rotation during the disengagement movement of the knife, which movement corresponds, particularly in the extremer case, to one complete rotation of the knife about the axis of rotation. In contrast to the engagement movement, the disengagement movement can therefore furthermore extend over an angle of one rotation about the axis of rotation, which in particular is approximately or exactly 360°.

In order to be able to perform the one or more blank cuts even more precisely and with the least risk of potential shredding, according to a further exemplary embodiment the feed unit can furthermore be designed to move the product caliber away from the cutting unit, in particular a cutting plane of the knife, during the execution of the one or more blank cuts, in order to perform a retraction movement opposite to the feed direction. Consequently, during the execution of the one or more blank cuts, not only can the knife be moved away from the product caliber, but the product caliber itself can also be moved away from the knife.

It should also be noted that the slicing machine may further comprise a gripper unit with at least one gripper which is designed to grip the at least one product caliber at its end facing away from the cutting unit.

Furthermore, the slicing machine may comprise, in a manner known per se, a portioning unit which is designed to form portions from the slices cut by the cutting unit, wherein each portion may comprise one or more slices.

In addition or alternatively, the slicing machine may further comprise a discharge conveying unit which is designed to discharge the slices cut by the cutting unit along a discharge direction in order to be able to further process the slices, and/or to package them, in particular by means of a packaging device arranged downstream of the slicing machine.

According to a further aspect, the disclosure relates to a method for slicing foodstuffs by means of a slicing machine, in particular according to the disclosure, comprising the following steps:

Feeding, by means of a feeding unit of the slicing machine, at least one product caliber along a feeding direction,

Slicing, by means of a cutting unit of the slicing machine, the at least one product caliber into slices, wherein a knife of the cutting unit is rotatably driven about an axis of rotation, and

Performing, by means of the cutting unit, a disengagement movement in order to perform one or more blank cuts, wherein the knife is moved along a direction substantially parallel to the axis of rotation of the knife from a slicing position, which is set to slice the at least one product caliber into slices, to a blank cutting position, in which no slice is cut from the at least one product caliber during a respective rotation of the knife about the axis of rotation,

wherein, after performing the one or more blank cuts, the cutting unit executes an engagement movement of the knife from the blank cut position to the slicing position, wherein the knife executes a movement about the axis of rotation during the engagement movement which corresponds to more than one complete revolution of the knife about the axis of rotation.

With regard to the advantages and actions of the method according to the disclosure, reference is made to the advantages and actions of the slicing machine according to the disclosure, in which all statements made with regard to the slicing machine also apply to the method and vice versa.

According to one embodiment, the movement of the knife during the engagement movement may correspond to a plurality of complete revolutions, preferably two complete revolutions, of the knife about the axis of rotation.

Furthermore, the disengagement movement can be performed with an acceleration and/or a speed of magnitude greater than an acceleration and/or a speed of the engagement movement.

### BRIEF DESCRIPTION OF THE DRAWINGS

The disclosure will be explained in more detail hereinbelow with reference to an exemplary embodiment and with the aid of the accompanying drawings, in which:

FIG. 1a shows an embodiment of a slicing machine according to the disclosure in a perspective view;

FIG. 1b shows the slicing machine according to FIG. 1a in a side view;

FIG. 2a shows a simplified schematic side view of an embodiment of a slicing machine according to the disclosure, based on FIGS. 1a and 1b, in which a knife of a cutting unit is in a slicing position;

FIG. 2b shows the schematic side view according to FIG. 2a, in which the knife is in a blank cutting position; and

FIG. 3 is a schematic diagram to explain the execution of a disengagement movement and a subsequent engagement movement of the cutting unit of the slicing machine according to the disclosure.

### DETAILED DESCRIPTION

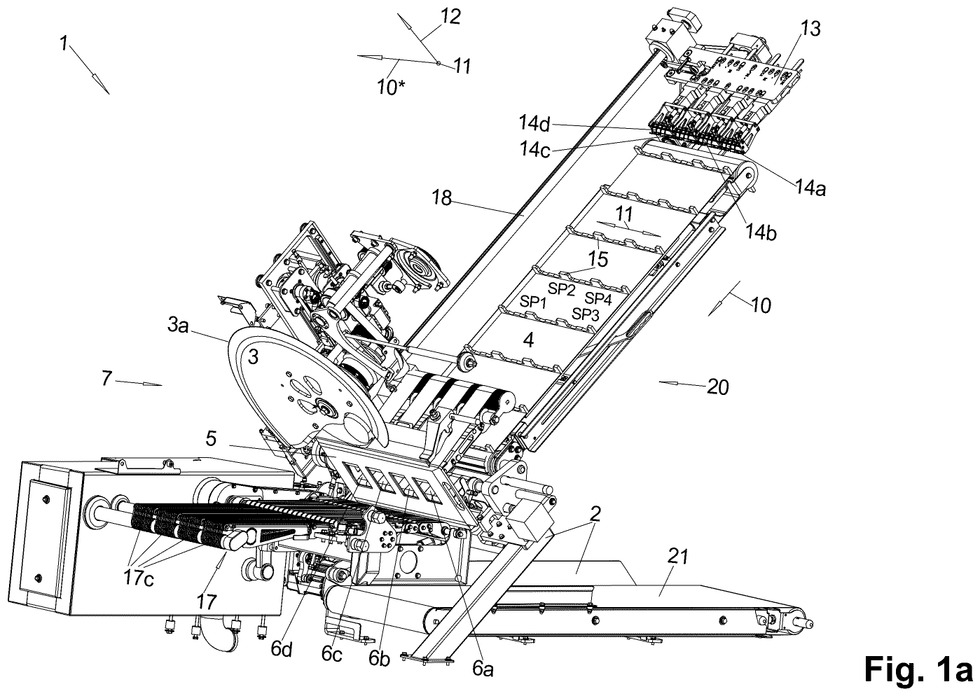

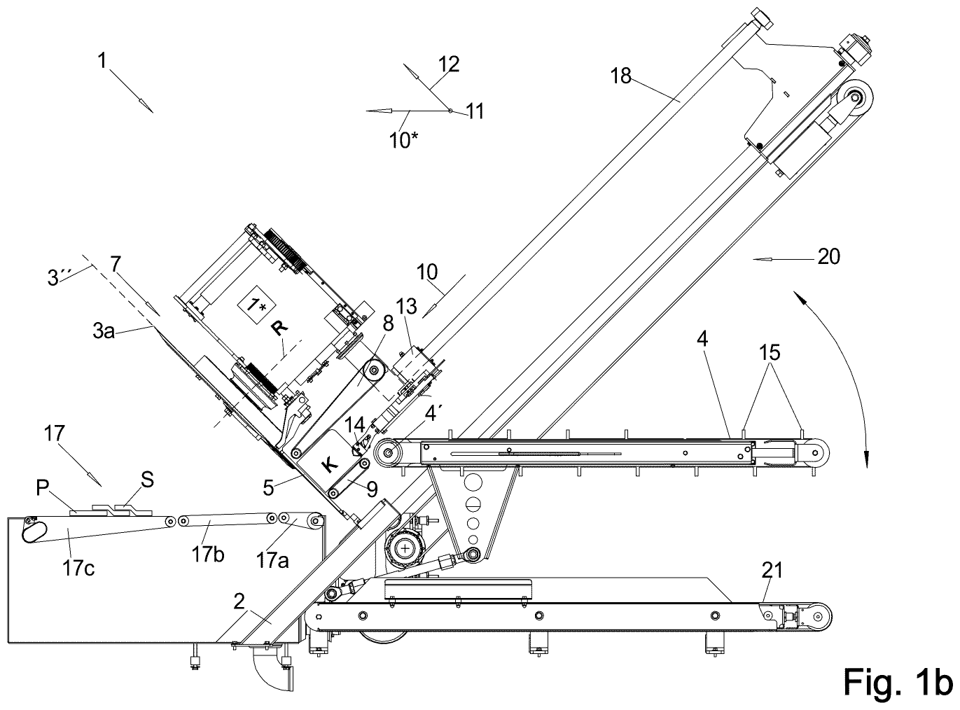

FIGS. 1a and 1b show a slicing machine 1 according to the disclosure according to an embodiment in the form of a multi-lane slicer 1 for the simultaneous slicing of several product calibers K on respectively one lane SP1 to SP4 next to one another and depositing them in shingled portions P each consisting of several slices S with a general direction of passage 10* through the slicer 1 from right to left.

FIG. 1b shows a side view of the slicer 1—with product caliber K inserted—without covers and other parts, attached to a base frame 2, which allow a better view and understanding of the functional parts, especially the conveyor belts. The longitudinal direction 10 is the feed direction of the product calibers K to a cutting unit 7 and thus also the longitudinal direction of the product calibers K located in the slicer 1.

In this case a cutting unit 7 of the slicer 1 with a knife 3 rotating about an axis of rotation R, for example a sickle knife 3, can be fed by a feed unit 20 with several, in this case four, product calibers K disposed next to one another transversely to the feed direction 10 on a feed conveyor 4 with projections 15 of the feed conveyor 4 protruding from a support surface serving as in-between spacers, from the front ends of which the rotating knife 3 can cut off a slice S with its cutting edge 3a during each revolution about the axis of rotation R.

In order to slice the product calibers K the feed conveyor 4 is in the inclined slicing position shown in FIG. 1a, with a lower cutting-side front end and a higher rear end, from which it can be folded down about a pivot axis 4′ running in its width direction, namely the first transverse direction 11, located near the cutting unit 7, into an approximately horizontal loading position, as shown in FIG. 1b.

The rear end of each product caliber K located in the feed unit 20 is held in a positive-locking manner by a gripper 14 or 14a-d with the aid of gripper claws. These grippers 14 or 14a-14d, which can be activated and deactivated with respect to the position of the gripper claws, are attached to a common gripper unit 13, which can be tracked along a gripper guide 18 in the feed direction 10.

In this connection the feed of the gripper unit 13 and also of the feed conveyor 4 can be driven in a controlled manner, whereby the actual feed rate of the product calibers K can however be governed by so-called upper and lower product guides 8, 9, which are likewise driven in a controlled manner and engage the upper side and the lower side of the product calibers K to be sliced in their front end regions near the cutting unit 7.

The front ends of the product calibers K are each guided through a product opening 6a-d of a plate-shaped cutting frame 5, wherein the cutting plane 3″ runs directly in front of the front, downwardly-facing inclined end face of the cutting frame 5, wherein in the cutting plane the knife 3 rotates with its cutting edge 3a about the axis of rotation R and thereby separates the excess portion of the product calibers K from the cutting frame 5 as a disk S. The cutting plane 3″ runs orthogonally to the upper run of the feed conveyor 4 and/or is spanned by the two transverse directions 11, 12 to the feed direction 10. The inner circumference of the product openings 6a-d serves as a counter knife-edge of the cutting edge 3a of the knife 3.

Since both product guides 8, 9 can be driven in a controlled manner, in particular independently of each other and/or possibly separately for each track SP1 to SP4, they determine a—continuous or clocked—feed speed of the product calibers K through the cutting frame 5.

The upper product guide 8 is displaceable in the second transverse direction 12, which runs orthogonally to the surface of the upper run of the feed conveyor 4, so it can adapt to a height of the product caliber K in this direction. Furthermore, at least one of the product guides 8, 9 can be designed to pivot about one of its deflection rollers so as to be able to change to a limited extent the direction of a guide belt of the product guide 8 and/or 9 adjacent to the respective product caliber K.

The slices S which are inclined in space during separation fall onto a discharge unit 17 located below the cutting frame 5 and running in the direction of travel 10* and which, in the illustrated embodiment, comprises a plurality of discharge conveyors 17a, 17b, 17c arranged behind one another in the direction of travel 10*, of which the first discharge conveyor 17a in the throughput direction 10* can be designed as a weighing unit 17a and in particular also as a portioning belt.

The slices S can impinge individually and spaced apart from one another on the discharge unit 17 in the throughput direction 10*, or shingled or stacked portions P (see FIG. 1b) can be formed by appropriate control of the weighing unit 17a, whose movement, like almost all moving parts, is controlled by a control unit 1* of the slicer 1. The portions P can in this case be formed for example by a stepwise forward movement of the portion P of the weighing unit 17a, which in this case also serves as a portioning belt, in the throughput direction 10*.

In the illustrated embodiment a substantially horizontally extending residue conveyor 21 is located below the feed unit 20, which begins with its front end underneath the cutting frame 5 and immediately below or behind the removal unit 17, and by means of its upper run can transport residues falling onto it away to the rear.

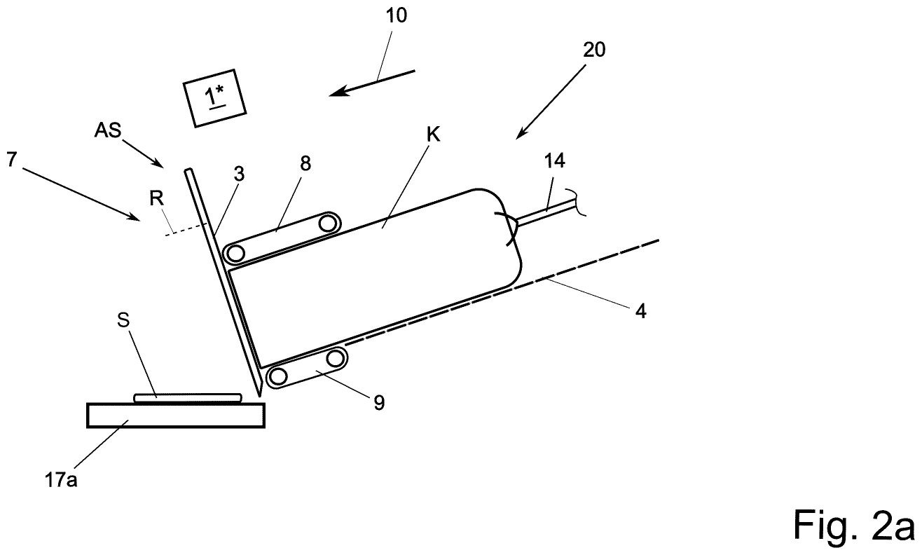

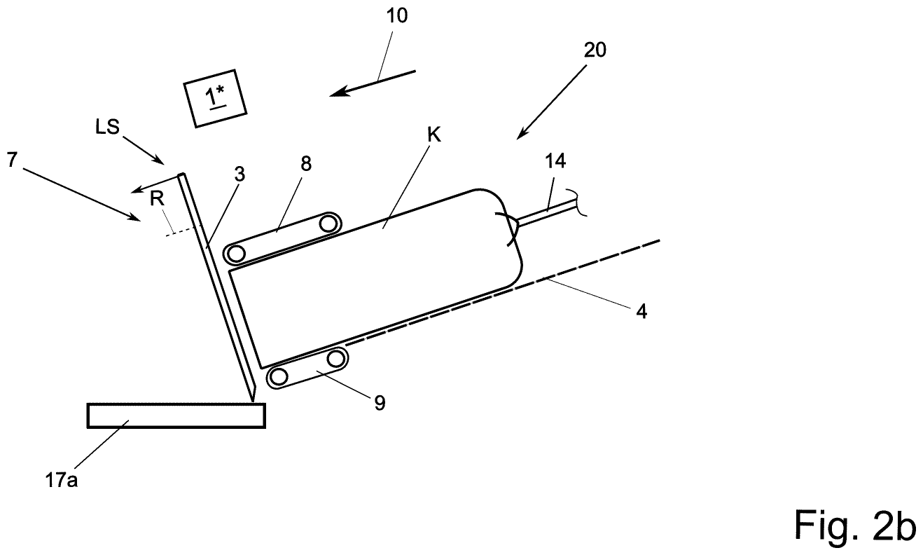

FIG. 2a shows a schematic side view, greatly simplified compared to FIGS. 1a and 1b, of a slicing machine 1 according to the disclosure. The slicing machine 1 can correspond in terms of its mode of operation to the slicing machine 1 described above with reference to FIGS. 1a and 1b. The feed unit 20 with the feed conveyor 4, the knife 3 of the cutting unit 7 and the control unit 1* as well as the upper product guide 8, the lower product guide 9 and the gripper 14 are shown only schematically in FIG. 2a. Furthermore, FIG. 2a schematically shows the afore-described discharge conveyor 17a, which can be designed as a portioning belt for the slices S.

In FIG. 2a the knife 3 is shown in a slicing position AS, which is adjusted for slicing the product caliber K into slices S.

In FIG. 2b however the knife 3 is shown in a blank cutting position LS, in which the knife 3, starting from FIG. 2a, has been moved away from the product caliber K by a predetermined amount substantially parallel to the feed direction 10. In the blank cutting position of the knife 3 no slice S is cut from the at least one product caliber K during each rotation of the knife 3 about the axis of rotation R. To perform a disengagement movement of the knife 3 from the slicing position shown in FIG. 2a to the blank cutting position shown in FIG. 2b and/or an engagement movement of the knife 3 from the blank cutting position shown in FIG. 2b to the slicing position shown in FIG. 2a, the cutting unit 7 can furthermore include a blank cutting drive unit (not shown), such as an electric actuator, which is designed to displace the knife 3 substantially parallel to the feed direction 10 and in the opposite direction thereto.

Optionally, the feed unit 20 can furthermore be designed to move the product caliber K away from the knife 3 substantially opposite to the feed direction 10 in order to perform one or more blank cuts, so as to more reliably prevent the occurrence of a possible shred formation during the execution of blank cuts.

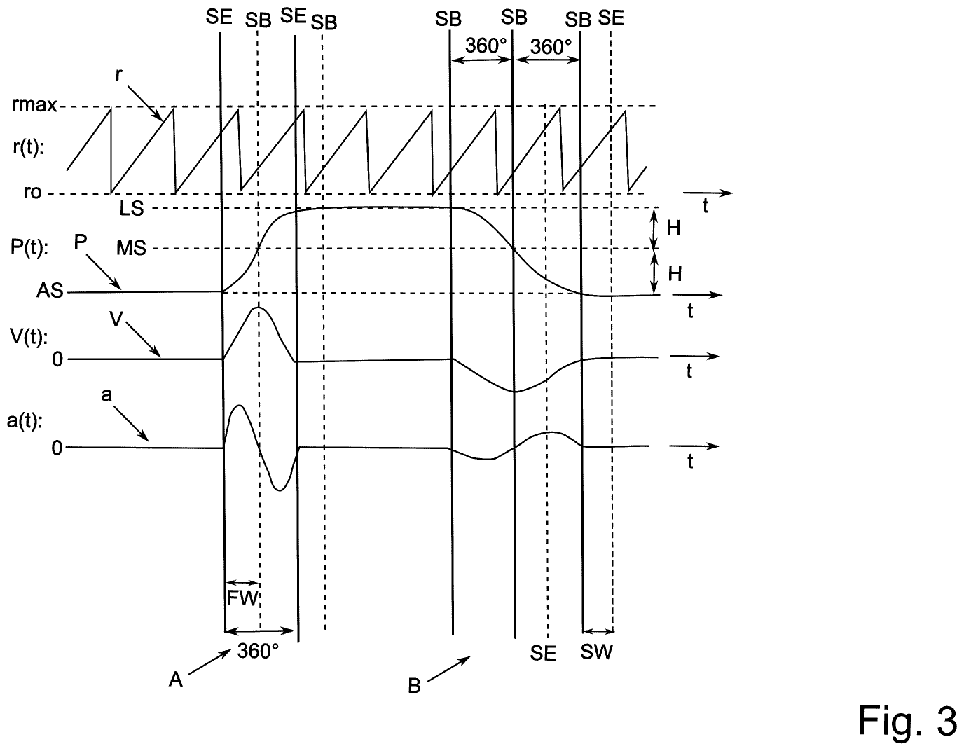

The execution of a disengagement movement A and a subsequent engagement movement B of the knife 3 is now schematically illustrated in FIG. 3 with the aid of corresponding graphs, in which the graph r(t) shows the time progression of the radius r of the knife 3 at a reference position, in particular a stationary position, on the slicing machine 1. In this connection the reference position can be arranged in the region of the cutting frame 5 (see FIGS. 1a and 1b) of the slicing machine 1. Since the knife 3 is shown as a sickle knife in the illustrated embodiment, the radius acting at the reference position exhibits a sawtooth-like behavior, wherein the radius increases linearly over time t up to a maximum radius r₀ and then drops abruptly to a base radius r₀, which can correspond to a minimum radius of the knife 3. It should be noted that the sawtooth-like behavior shown in FIG. 3 is simply schematic, and the actual behavior of the radius of the sickle knife 3 may deviate from the behavior shown.

Furthermore, the position P of the cutting knife 3 as a function of time is shown in FIG. 3. The zero line of the curve P(t) can correspond to the slicing position AS of the knife 3, which is illustrated for example in FIG. 2a. Starting from the slicing position AS, the knife 3 can in this case be moved by a disengagement stroke in the feed direction 10 to the blank cutting position LS, wherein the disengagement stroke required for this in the feed direction 10 may correspond in magnitude to twice a minimum stroke H. In the illustrated embodiment the minimum stroke H is in this case the stroke required to prevent the knife 3 from engaging with the product caliber K during one complete rotation of the knife 3 about the axis of rotation R.

The graph V(t) accordingly shows the speed V of the knife 3 as a function of time t and represents the time derivative of the graph P(t). Finally, the graph a(t) shows the acceleration a of the knife 3 as a function of time t, wherein the graph a(t) can accordingly correspond to the time derivative of the graph V(t).

As can further be seen in FIG. 3, according to the illustrated exemplary embodiment the disengagement movement A of the knife 3 from the slicing position AS to the blank cutting position LS begins at a cutting end rotation angle position SE of the knife 3, wherein the cutting end rotation angle position SE of the knife 3 can correspond to a rotation angle position of the knife 3 about the axis of rotation R at which the knife 3 no longer engages with the product caliber K for the first time after a respective slice S has been sliced in the slicing position AS. In this connection it can be seen that the knife 3 reaches the minimum stroke H approximately, preferably exactly, when a cutting start rotation angle position SB of the knife 3 is reached, wherein the cutting start rotation angle position SB may correspond to a rotation angle position of the knife 3 about the axis of rotation R at which the knife 3 engages with the product caliber K for the first time when slicing a respective slice S in the slicing position AS. In other words, a respective rotation angle range of the knife 3 between a respective cutting start rotation angle position SB and a respective cutting end rotation angle position SE in FIG. 3 thus describes a cutting angle range SW in which the knife 3 engages with the product caliber K. The angular range between a respective cutting end rotation angle position SE and a respective cutting start rotation angle position SB corresponds on the other hand to a clearance angle range FW in which the knife 3 does not engage with the product caliber K in the slicing position during a rotation about the axis of rotation R.

As can also be seen in FIG. 3, in the present exemplary embodiment the disengagement movement A extends from the slicing position AS to the blank cut position LS over an angle of 360°, while the engagement movement B extends from the blank cut position LS to the slicing position AS over an angle of twice 360°, i.e. 720° in total, which corresponds to two complete revolutions of the knife 3 about the axis of rotation R. Since the engagement movement B extends over an angular range and/or length of time which is twice as large as the angular range or twice as long as the length of time of the disengagement movement A, the knife 3 has a correspondingly significantly lower speed V or acceleration a during the engagement movement B, which can correspondingly lead to lower loads on components of the slicing machine 1, in particular the blank cut drive unit of the knife 3 and/or other components of the cutting unit 7.

As can also be seen in FIG. 3, the engagement movement B begins at a cutting start SB, which means that after completion of the engagement movement B, which in this case corresponds to two complete revolutions of the knife 3, the knife 3 is again at or immediately in front of the cutting start rotation angle position SB, so that the slicing of a new slice S can begin immediately.

It should also be noted that after the knife 3 has performed the simple minimum stroke H starting from the blank cutting position LS (see graph P(t)), the knife 3 is in a middle position MS, in which the knife 3 is still remote from the slicing position AS by the further minimum stroke H, so that there is no contact between the knife 3 and the product caliber K, and thus no undesirable shredding, even when the knife 3 in the middle position MS passes through the cutting start rotation angle position SB once more.

As one skilled in the art would understand, the control unit 1*, the drive unit(s), as well as any other control, controller, unit, system, subsystem, sensor, or the like described herein may individually, collectively, or in any combination comprise appropriate circuitry, such as one or more appropriately programmed processors (e.g., one or more microprocessors including central processing units (CPU)) and associated memory, which may include stored operating system software, firmware, and/or application software executable by the processor(s) for controlling operation thereof and for performing the particular algorithm or algorithms represented by the various methods, functions and/or operations described herein, including interaction between and/or cooperation with each other. One or more of such processors, as well as other circuitry and/or hardware, may be included in a single Application-Specific Integrated Circuitry (ASIC), or several processors and various circuitry and/or hardware may be distributed among several separate components, whether individually packaged or assembled into a System-on-a-Chip (SoC).

What is claimed is:

1. A slicing machine for slicing foodstuffs, comprising:
a feed unit which is designed to feed at least one product caliber along a feed direction; and
a cutting unit which is designed to slice the at least one product caliber into slices;
wherein the cutting unit comprises a knife which can be rotatably driven about an axis of rotation;
wherein the cutting unit is designed to carry out a disengagement movement in order to perform one or more blank cuts, in which the knife is moved along a direction substantially parallel to the axis of rotation of the knife from a slicing position, which is set to slice the at least one product caliber into slices, to a blank cut position, in which no slice is cut from the at least one product caliber during a respective rotation of the knife about the axis of rotation; and
wherein the cutting unit is designed to perform an engagement movement of the knife from the blank cut position to the slicing position after the one or more blank cuts have been carried out, wherein the knife is operable to execute a movement about the axis of rotation during the engagement movement which corresponds to more than one complete revolution of the knife about the axis of rotation.

2. The slicing machine according to claim 1, wherein the movement of the knife about the axis of rotation during the engagement movement corresponds to a plurality of complete revolutions of the knife about the axis of rotation.

3. The slicing machine according to claim 2, wherein the plurality of complete revolutions comprises two complete revolutions.

4. The slicing machine according to claim 1, wherein a start of the engagement movement corresponds to a cutting start rotation angle position of the knife about the axis of rotation, wherein the cutting start rotation angle position corresponds to a rotation angle position of the knife about the axis of rotation at which a cutting edge of the knife engages with the at least one product caliber for a first time when a respective slice is cut in the slicing position.

5. The slicing machine according to claim 1, wherein a start of the disengagement movement corresponds to a cutting end rotation angle position of the knife about the axis of rotation, wherein the cutting end rotation angle position corresponds to a rotation angle position of the knife about the axis of rotation at which the knife no longer engages with the at least one product caliber for a first time after a respective slice is cut in the slicing position.

6. The slicing machine according to claim 1, wherein an engagement stroke of the engagement movement against the feed direction and/or a disengagement stroke of the disengagement movement in the feed direction are/is greater in magnitude than a minimum stroke which is required in order to prevent an engagement of the knife with the at least one product caliber in the blank cut position.

7. The slicing machine according to claim 6, wherein the engagement stroke and/or the disengagement stroke correspond/corresponds to at least approximately twice the minimum stroke.

8. The slicing machine according to claim 1, wherein the cutting unit is designed to perform the disengagement movement with an acceleration and/or a speed which are/is greater in magnitude than an acceleration and/or a speed of the engagement movement.

9. The slicing machine according to claim 1, wherein the cutting unit is designed to perform at least part of the disengagement movement only within a clearance angle range of the knife in which the knife in the slicing position does not engage with the product caliber during rotation about the axis of rotation.

10. The slicing machine according to claim 1, wherein the knife is designed as a sickle knife having a radius which varies,.

11. The slicing machine according to claim 10, wherein the radius increases in a circumferential direction about the axis of rotation.

12. The slicing machine according to claim 1, wherein the disengagement movement and/or the engagement movement have/has a stroke in the feed direction in a range of more than 0 mm to 10 mm.

13. The slicing machine according to claim 12, wherein the range is from 3 mm to 5 mm. 14 The slicing machine according to claim 1, wherein the cutting unit is designed to execute a movement about the axis of rotation during the disengagement movement of the knife, the movement corresponding to at most one complete revolution of the knife about the axis of rotation.

15. The slicing machine according to claim 1, wherein the feed unit is furthermore designed to move the at least one product caliber away from the cutting unit when executing the one or more blank cuts, in order to perform a retraction movement opposite to the feed direction.

16. A method for slicing foodstuffs by a slicing machine, the method comprising:
feeding, by a feed unit of the slicing machine, at least one product caliber along a feed direction; and
slicing, by a cutting unit of the slicing machine, the at least one product caliber into slices, wherein a knife of the cutting unit is rotatably driven about an axis of rotation; and
performing, by the cutting unit, a disengagement movement for carrying out one or more blank cuts, wherein the knife is moved along a direction substantially parallel to the axis of rotation of the knife from a slicing position, which is set to slice the at least one product caliber into slices, to a blank cut position, in which no slice is cut from the at least one product caliber during a respective rotation of the knife about the axis of rotation;
wherein, after performing the one or more blank cuts, the cutting unit carries out an engagement movement of the knife from the blank cut position to the slicing position, wherein the knife performs a movement about the axis of rotation during the engagement movement which corresponds to more than one complete revolution of the knife about the axis of rotation.

17. The method according to claim 16, wherein the movement of the knife during the engagement movement corresponds to a plurality of complete revolutions of the knife about the axis of rotation.

18. The method according to claim 17, wherein the plurality of complete revolutions comprises two complete revolutions.

19. The method according to claim 16, wherein the disengagement movement is carried out with an acceleration and/or a speed which are/is greater in magnitude than an acceleration and/or a speed of the engagement movement.
